(19) United States
(12) Patent Application Publication
(10) Pub. No.: US 2007/0292336 A1
(43) Pub. Date: Dec. 20, 2007

(54) PROCESSES FOR THE PREPARATION OF CHLORINE BY GAS PHASE OXIDATION

(75) Inventors: Aurel Wolf, Wulfrath (DE); Jurgen Kintrup, Leverkusen (DE); Oliver Felix-Karl Schluter, Leverkusen (DE); Leslaw Mleczko, Dormagen (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/752,547

(22) Filed: May 23, 2007

(30) Foreign Application Priority Data
May 23, 2006 (DE) 102006024543.1

(51) Int. Cl. C01B 7/04

(52) U.S. Cl. 423/502

(57) ABSTRACT

Processes are disclosed comprising: (a) providing a gas phase comprising hydrogen chloride and oxygen; and (b) oxidizing the hydrogen chloride with the oxygen in the presence of a catalyst comprising tin dioxide and at least one oxygen-containing ruthenium compound.

### BACKGROUND OF THE INVENTION

The process of catalytic oxidation of hydrogen chloride with oxygen in an exothermic equilibrium reaction, developed by Deacon in 1868, was at the beginning of industrial chlorine chemistry;
4 HCl+O₂ [symbol] 2 Cl₂+2 H₂O

However, the Deacon process was pushed severely into the background by chlor-alkali electrolysis. Eventually, virtually the entire production of chlorine was accomplished by electrolysis of aqueous sodium chloride solutions (Ullmann Encyclopedia of Industrial Chemistry, seventh release, 2006). However, the attractiveness of Deacon processes has recently been increasing again, since worldwide demand for chlorine is growing faster than the demand for sodium hydroxide solution. Processes for the preparation of chlorine by oxidation of hydrogen chloride, which does not produce sodium hydroxide solution as a by-product, satisfies this development. Furthermore, hydrogen chloride is available as a by-product in large quantities, for example, from phosgenation reactions, as in the preparation of isocyanates.

The oxidation of hydrogen chloride to chlorine is an equilibrium reaction. The position of the equilibrium shifts to the disfavor of the desired end product as the temperature increases. It is therefore advantageous to employ catalysts with the highest possible activity, which allow the reaction to proceed at a low temperature.

The first catalysts for oxidation of hydrogen chloride contained copper chloride or oxide as the active component and were already described by Deacon in 1868. However, these had only low activities at a low temperature (<400° C.). By increasing the reaction temperature, it was indeed possible to increase the activity, but a disadvantage was that the volatility of the active components at higher temperatures led to a rapid decrease in the activity of the catalyst.

The oxidation of hydrogen chloride with catalysts based on chromium oxides is known. However, the process realized by this means has an inadequate activity and high reaction temperatures.

Catalysts for the oxidation of hydrogen chloride containing the catalytically active component ruthenium have been known since 1965. Such early ruthenium-based catalysts included RuCl₃, e.g., supported on silicon dioxide and aluminium oxide. However, the activity of these RuCl₃/SiO₂ catalysts can be very low. Further Ru-based catalysts with the active mass of ruthenium oxide or ruthenium mixed oxide and various oxides, such as e.g., titanium dioxide, zirconium dioxide etc., as the support material have also been described. In such catalysts, the content of ruthenium oxide can be 0.1 wt. % to 20 wt. % and the average particle diameter of ruthenium oxide can be 1.0 nm to 10.0 nm.

Further Ru catalysts supported on titanium dioxide or zirconium dioxide are known. A number of Ru starting compounds, such as e.g., ruthenium-carbonyl complexes, ruthenium salts of inorganic acids, ruthenium-nitrosyl complexes, ruthenium-amine complexes, ruthenium complexes of organic amines or ruthenium-acetylacetonate complexes, have been suggested for the preparation of ruthenium chloride and ruthenium oxide catalysts which contain at least one compound of titanium oxide and zirconium oxide. Rutile form TiO₂ as the support material has been suggested. Such ruthenium oxide catalysts have a quite high activity, but the use thereof is expensive and requires a number of operations, such as precipitation, impregnation with subsequent precipitation etc., scale-up of which is difficult industrially. In addition, at high temperatures Ru oxide catalysts also tend towards sintering and thus towards deactivation.

EP 0936184 A2 describes a process for the catalytic oxidation of hydrogen chloride, wherein the catalyst is chosen from an extensive list of possible catalysts. Among the catalysts is the variant designated number (6), which comprises the active component (A) and a component (B). Component (B) is a compound component which has a certain thermal conductivity. Tin dioxide, inter alia, is mentioned as an example. In addition, component (A) can be absorbed on to a support. However, possible supports do not include tin dioxide. There is also not a singe example in which tin dioxide was used.

The catalysts developed to date for the Deacon process have a number of inadequacies. At low temperatures, the activity thereof is inadequate. It was indeed possible to increase the activity by increasing the reaction temperature, but this led to sintering/deactivation or to a loss of the catalytic component.

### BRIEF SUMMARY OF THE INVENTION

One object of the present invention includes providing a catalytic system which can effect the oxidation of hydrogen chloride at low temperatures and with high activities. This object can be achieved with the inventive development of specific combinations of catalytically active components and specified support materials.

It has been found, surprisingly, that by targeted supporting of an oxygen-containing ruthenium compound on tin dioxide, likely due to a particular interaction between the catalytically active component and support, novel highly active catalysts can be provided which have a high catalytic activity in the oxidation of hydrogen chloride, especially at temperatures of ≦350° C. A further advantage of the catalyst systems according to the invention is the simple application of the catalytically active component to the support, which is also less difficult to scale up than previously known catalyst systems.

The present invention relates to a process for the preparation of chlorine by catalytic gas phase oxidation of hydrogen chloride with oxygen, wherein the catalyst comprises tin dioxide and at least one oxygen-containing ruthenium compound. The present invention also relates to catalysts for gas phase oxidation which are based on tin dioxide as a carrier material and an oxygen-containing ruthenium compound.

One embodiment of the present invention includes a process comprising: (a) providing a gas phase comprising hydrogen chloride and oxygen; and (b) oxidizing the hydrogen chloride with the oxygen in the presence of a catalyst comprising tin dioxide and at least one oxygen-containing ruthenium compound.

### DETAILED DESCRIPTION OF THE INVENTION

As used herein, the singular terms “a” and “the” are synonymous and used interchangeably with “one or more.” Accordingly, for example, reference to “a compound” herein or in the appended claims can refer to a single compound or more than one compound. Additionally, all numerical values, unless otherwise specifically noted, are understood to be modified by the word “about.”

In various preferred embodiments of processes according to the present invention, tin (IV) oxide can be employed as the support for the catalytically active component, particularly preferably tin dioxide in the rutile structure.

According to the invention, the catalytically active component comprises an oxygen-containing ruthenium compound. This is a compound in which oxygen is bonded to a ruthenium atom, e.g., ionically, polarized, covalently, etc.

Preferred catalytically active ruthenium compounds in the context of the invention include ruthenium oxyhalides, and are preferably obtainable by a process which comprises initially the application of an aqueous solution or suspension of at least one halide-containing ruthenium compound (e.g., chloride) to tin dioxide and the subsequent precipitation and optionally the calcining of the precipitated product.

Precipitation can be carried out under alkaline conditions with direct formation of the oxygen-containing ruthenium compound. It can also be carried out under reducing conditions with primary formation of metallic ruthenium, which can then be calcined while oxygen is fed in, the oxygen-containing ruthenium compound forming. Alternatively, the oxygen-containing ruthenium compound can also be obtained by applying metallic ruthenium to tin dioxide, followed by oxidation of the ruthenium metal in an oxygen-containing gas or in particular by exposing the metallic ruthenium on tin dioxide to a gas composition of the feed gases for a Deacon reaction, i.e. to gases containing at least HCl and oxygen. For example ruthenium is applied in the form of the metal to the tin dioxide by means of CVD or MOCVD processes.

A preferred process includes the application of an aqueous solution of RuCl₃ to the tin dioxide.

The application preferably includes impregnation of the optionally freshly precipitated tin dioxide with the solution of the halide-containing ruthenium compound.

After the application of the halide-containing ruthenium compound, a precipitating and a drying or calcining step, which is expediently carried out in the presence of oxygen or air at temperatures of up to 650° C., can be carried out.

The loading of the catalytically active component, i.e., the oxygen-containing ruthenium compound, is conventionally in the range of 0.1-80 wt. %, preferably in the range of 1-50 wt. %, particularly preferably in the range of 1-20 wt. %, based on the total weight of the catalyst (catalyst component and support).

Particularly preferably, the catalytic component, i.e., the oxygen-containing ruthenium compound, can be applied to the support, for example, by moist and wet impregnation of a support with suitable starting compounds present in solution or starting compounds in liquid or colloidal form, precipitation and co-precipitation processes, and ion exchange and gas phase coating (CVD, PVD).

Possible promoters are metals have a basic action (e.g., alkali, alkaline earth and rare earth metals), alkali metals, in particular Na and Cs, and alkaline earth metals are preferred, and alkaline earth metals, in particular Sr and Ba, are particularly preferred.

The promoters can be applied to the catalyst by impregnation and CVD processes, without being limited thereto, and an impregnation is preferred, particularly preferably after application of the catalytic main component.

For stabilization of the dispersion of the catalytic main component on the support, various dispersion stabilizers, such as, for example, scandium oxides, manganese oxides and lanthanum oxides etc., can be employed, for example, without being limited thereto. The stabilizers are preferably applied by impregnation and/or precipitation together with the catalytic main component.

Tin dioxide suitable for use according to the invention is commercially obtainable (e.g., from Chempur, Alfa Aesar) or obtainable, for example, by alkaline precipitation of tin(IV) chloride and subsequent drying. Tin dioxide suitable for use according to the invention preferably has, in particular, BET surface areas of from about 1 to 300 m²/g.

The tin dioxide used as the support according to the invention can undergo a reduction in the specific surface area under exposure to heat (such as at temperatures of more than 250° C.), which can be accompanied by a reduction in the activity of the catalyst. The abovementioned dispersion stabilizers can also serve to stabilize the surface of the tin dioxide at high temperatures.

The catalysts can be dried under normal pressure or, preferably, under reduced pressure, preferably at 40 to 200° C. The duration of the drying is preferably 10 min to 6 h.

Preferably, catalysts according to the present invention are used, as already described above, in the catalytic process known as the Deacon process. In such processes hydrogen chloride is oxidized with oxygen in an exothermic equilibrium reaction to form chlorine, with the formation of steam. The reaction temperature is usually 150 to 500° C., and the normal reaction pressure is 1 to 25 bar. Since the reaction is an equilibrium reaction, it is appropriate to use the lowest possible temperatures at which the catalyst still has sufficient activity. It is also appropriate for oxygen to be used in superstoichiometric quantities in relation to the hydrogen chloride. A two- to four-fold oxygen excess is for example commonly used. Since no selectivity losses need to be feared, it can be economically advantageous to carry out the reaction at a relatively high pressure and an accordingly longer residence time than when using normal pressure.

In addition to a ruthenium compound, suitable catalysts can also be compounds of other noble metals, such as for example gold, palladium, platinum, osmium, iridium, silver, copper or rhenium. Suitable catalysts can also contain chromium(III) oxide.

The catalytic hydrogen chloride oxidation can be carried out adiabatically or preferably isothermally or approximately isothermally, or discontinuously, but preferably continuously in the form of a fluidized or fixed bed process, and preferably in the form of a fixed bed process, and particularly preferably in tube bundle reactors on heterogeneous catalysts at a reactor temperature of 180 to 500° C., preferably 200 to 400° C., particularly preferably 220 to 350° C. and a pressure of 1 to 25 bar (1000 to 25000 hPa), preferably 1.2 to 20 bar, particularly preferably 1.5 to 17 bar and in particular 2.0 to 15 bar.

Conventional reaction apparatuses in which the catalytic hydrogen chloride oxidation is carried out are fixed bed or fluidized bed reactors. Catalytic hydrogen chloride oxidation can preferably also be carried out in several stages.

For the adiabatic, isothermal or approximately isothermal mode of operation it is also possible to use more than one, i.e. 2 to 10, preferably 2 to 6, particularly preferably 2 to 5, and in particular 2 to 3 series-connected reactors with intermediate cooling. The oxygen can be added either completely together with the hydrogen chloride upstream of the first reactor or in a distributed manner over the various reactors. This series connection of individual reactors can also be combined in one apparatus.

An additional preferred variant of a device suitable for the process consists in using a structured catalyst bed in which the catalyst activity increases in the direction of flow. Such structuring of the catalyst bed can be obtained by varying the impregnation of the catalyst support with the active composition or varying the dilution of the catalyst with an inert material. The inert material used can for example be rings, cylinders or beads of titanium dioxide, zirconium dioxide or mixtures thereof, aluminium oxide, steatite, ceramics, glass, graphite or stainless steel. In the case of the preferred use of shaped catalysts, the inert material should preferably have similar external dimensions.

Suitable shaped catalysts have any desired shapes. Preferably the catalysts are shaped in the form of tablets, rings, cylinders, stars, wheels or beads. Particularly preferred shapes are rings, cylinders or star-shaped strands.

Suitable support materials which can be combined with tin dioxide are for example silicon dioxide, graphite, titanium dioxide with a rutile or anatase structure, zirconium dioxide, aluminium oxide or mixtures thereof, and preferably titanium dioxide, zirconium dioxide, aluminium oxide or mixtures thereof, and particularly preferably γ- or δ-aluminium oxide or mixtures thereof.

Suitable promoters for doping the catalysts are alkali metals such as lithium, sodium, potassium, rubidium and cesium, preferably lithium, sodium and potassium, particularly preferably potassium, alkaline earth metals such as magnesium, calcium strontium and barium, preferably magnesium and calcium, particularly preferably magnesium, rare earth metals such as scandium, yttrium, lanthanum, cerium, praseodyminum and neodymium, preferably scandium, yttrium, lanthanum and cerium, particularly preferably lanthanum and cerium, or mixtures thereof.

The shaped catalysts can then be dried at a temperature of 100 to 400° C., preferably 100 to 300° C., for example under a nitrogen, argon or air atmosphere, and optionally calcined. Preferably the shaped catalysts are initially dried at 100 to 150° C. and then calcined at 200 to 400° C.

The conversion rate of hydrogen chloride in a single passage can preferably be limited to 15 to 90%, preferably 40 to 85%, and particularly preferably 50 bis 70%. Any non-converted hydrogen chloride can be separated off and partially or completely recycled to the catalytic hydrogen chloride oxidation process. The volumetric ratio of hydrogen chloride to oxygen at the inlet of the reactor is preferably between 1:1 and 20:1, preferably between 2:1 and 8:1, and particularly preferably between 2:1 and 5:1.

The heat of reaction of the catalytic hydrogen chloride oxidation can advantageously be used for the production of high-pressure steam. This can be used for operating a phosgenation reactor or distillation columns, and in particular isocyanate distillation columns.

In an additional step the chlorine formed is separated off. The separation step usually comprises more than one stage, namely the separation and optional recycling of non-converted hydrogen chloride from the product gas stream of the catalytic hydrogen chloride oxidation, drying the resulting stream essentially containing chlorine and oxygen and separating chlorine from the dried stream.

The separation of non-converted hydrogen chloride and of steam which has formed can be carried out by condensing aqueous hydrochloric acid out of the product gas stream of the hydrogen chloride oxidation by cooling. Hydrogen chloride can also be absorbed in dilute hydrochloric acid or water.

The catalysts according to the invention for the oxidation of hydrogen chloride are distinguished by a high activity at low temperatures.

The following examples are for reference and do not limit the invention described herein.

### EXAMPLES

### Example 1

### Supporting of Ruthenium Oxide on Tin(IV) Oxide

20 g of commercially available tin(IV) oxide were suspended in a solution of 2.35 g of commercially obtainable ruthenium chloride n-hydrate in 50 ml of water in a round-bottomed flask with a dropping funnel and reflux condenser and the mixture was stirred for 30 min. 24 g of 10% strength sodium hydroxide solution were then added dropwise in the course of 30 min and the mixture was stirred for 30 min. A further 12 g of 10% strength sodium hydroxide solution were subsequently added dropwise in the course of 15 min and the reaction mixture was heated to 65° C. and kept at this temperature for 1 h. After cooling, the suspension was filtered and the solid was washed 5 times with 50 ml of water. The moist solid was dried at 120° C. in a vacuum drying cabinet for 4 h and then calcined at 300° C. in a stream of air, a ruthenium oxide catalyst supported on tin(IV) oxide being obtained. The calculated amount of ruthenium was Ru/(RuO₂+SnO₂)=4.7 wt. %.

### Example 2 (Comparative)

### Supporting Ruthenium Oxide on Tin(IV) Oxide

20 g of commercially available titanium(IV) oxide were suspended in a solution of 2.35 g of commercially obtainable ruthenium chloride n-hydrate in 50 ml of water in a round-bottomed flask with a dropping funnel and reflux condenser and the mixture was stirred for 30 min. 24 g of 10% strength sodium hydroxide solution were then added dropwise in the course of 30 min and the mixture was stirred for 30 min. A further 12 g of 10% strength sodium hydroxide solution were subsequently added dropwise in the course of 15 min and the reaction mixture was heated to 65° C. and kept at this temperature for 1 h. After cooling, the suspension was filtered and the solid was washed 5 times with 50 ml of water. The moist solid was dried at 120° C. in a vacuum drying cabinet for 4 h and then calcined at 300° C. in a stream of air, a ruthenium oxide catalyst supported on titanium(IV) oxide being obtained. The calculated amount of ruthenium was Ru/(RuO₂+TiO₂)=4.7 wt. %.

### Example 3 (Reference)

### Blank Experiment with Tin Dioxide

As a blank experiment, tin dioxide was used instead of a catalyst and was tested as described below. The small amount of chlorine produced is to be attributed to the gas phase reaction.

Catalyst Tests

Use of the catalysts in the oxidation of HCl

A gas mixture of 80 ml/min (STP) of hydrogen chloride and 80 ml/min (STP) of oxygen flowed through the catalysts from the example, the comparison example and the reference example in a packed fixed bed in a quartz reaction tube (diameter 10 mm) at 300° C. The quartz reaction tube was heated by an electrically heated fluidized bed of sand. After 30 min the product gas stream was passed into 16% strength potassium iodide solution for 10 min. The iodine formed was then back-titrated with 0.1 N thiosulfate standard solution in order to determine the amount of chlorine passed in. Table 1 shows the results.

TABLE 1
Activity in the oxidation of HCl

| | | Chlorine formation | Chlorine formation |
|---|---|---|---|
| Example | Composition | mmol/min · g (cat) | mmol/min · g (Ru) |
| 1 | RuO₂/SnO₂ | 0.48 | 10.3 |
| | (4.7% Ru) | | |
| 2 (comp.) | RuO₂/TiO₂ | 0.38 | 8.1 |
| | (4.7% Ru) | | |
| 3 (ref.) | SnO₂ | (0.08) | — |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) providing a gas phase comprising hydrogen chloride and oxygen; and
(b) oxidizing the hydrogen chloride with the oxygen in the presence of a catalyst comprising tin dioxide and at least one oxygen-containing ruthenium compound.

2. The process according to claim 1, wherein the catalyst is prepared by a process comprising applying an aqueous form of at least one halide-containing ruthenium compound to the tin dioxide; and precipitating the at least one oxygen-containing ruthenium compound and tin dioxide under alkaline conditions.

3. The process according to claim 2, wherein the at least one halide-containing ruthenium compound comprises an aqueous solution of RuCl₃.

4. The process according to claim 1, wherein the hydrogen chloride is oxidized at a reaction temperature up to 450° C.

5. The process according to claim 2, wherein the hydrogen chloride is oxidized at a reaction temperature up to 450° C.

6. The process according to claim 3, wherein the hydrogen chloride is oxidized at a reaction temperature up to 450° C.

7. The process according to claim 1, wherein the tin dioxide comprises rutile form SnO₂.

8. The process according to claim 2, wherein the tin dioxide comprises rutile form SnO₂.

9. The process according to claim 3, wherein the tin dioxide comprises rutile form SnO₂.

10. The process according to claim 4, wherein the tin dioxide comprises rutile form SnO₂.

11. The process according to claim 5, wherein the tin dioxide comprises rutile form SnO₂.

12. The process according to claim 6, wherein the tin dioxide comprises rutile form SnO₂.
